(19) United States
(12) Patent Application Publication
(10) Pub. No.: US 2024/0275215 A1
(43) Pub. Date: Aug. 15, 2024

(54) WIRELESS COMMUNICATION ENERGY HARVESTING TECHNIQUES

(71) Applicant: QUALCOMM Incorporated, San Diego, CA (US)

(72) Inventors: Ahmed Elshafie, San Diego, CA (US); Sony Akkarakaran, Poway, CA (US); Yu Zhang, San Diego, CA (US); Alexandros Manolakos, Athens (GR)

(21) Appl. No.: 18/291,082

(22) PCT Filed: Sep. 26, 2021
(86) PCT No.: PCT/CN2021/120551

§ 371 Date: Jan. 22, 2024

(51) Int. Cl. H02J 50/80; H02J 50/20; H04L 5/00

(52) U.S. Cl. CPC H02J 50/80; H02J 50/20; H04L 5/0051

(57) ABSTRACT

An apparatus for wireless communication includes a receiver configured to receive, from a device, a charging signal that is based on one or more time domain taps and that is associated with a data signal. The apparatus further includes a transmitter configured to transmit, to the device, a feedback signal associated with the charging signal. The feedback signal indicates at least one parameter that is detected by the apparatus and that is associated with the one or more time domain taps. Other aspects and features are also described.

### TECHNICAL FIELD

Aspects of the present disclosure relate generally to wireless communication systems, and more particularly, to wireless communication systems that use charging signals. Some embodiments and aspects enable and provide energy harvesting techniques to harness and leverage power from wireless signals transmitted in wireless communication networks.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

To reduce or compensate for noise and interference, some devices may use certain techniques that may increase power consumption. For example, a UE may transmit or receive a signal having a relatively large amplitude or power, such as by applying a relatively large amount of amplification to the signal using a power amplifier (PA) or a low-noise amplifier (LNA). Such techniques may consume device power. In the case of some devices, such as battery-powered devices, such power consumption may reduce device performance and involve relatively frequent device charging.

### BRIEF SUMMARY OF SOME EXAMPLES

In some aspects of the disclosure, an apparatus for wireless communication includes a receiver configured to receive, from a device, a charging signal that is based on one or more time domain taps and that is associated with a data signal. The apparatus further includes a transmitter configured to transmit, to the device, a feedback signal associated with the charging signal. The feedback signal indicates at least one parameter that is detected by the apparatus and that is associated with the one or more time domain taps.

In some other aspects of the disclosure, a method of wireless communication performed by a first device includes receiving, from a second device, a charging signal that is based on one or more time domain taps and that is associated with a data signal. The method further includes transmitting, to the second device, a feedback signal associated with the charging signal. The feedback signal indicates at least one parameter that is detected by the first device and that is associated with the one or more time domain taps.

In some other aspects, an apparatus for wireless communication includes a transmitter and a receiver configured to receive a data signal. The receiver is further configured to receive a charging signal that is based on one or more time domain taps and to remove one or more signal components of the charging signal from the data signal.

In some other aspects, a method of wireless communication performed by a first device includes transmitting a data signal to a second device. The method further includes transmitting a charging signal that is based on one or more time domain taps and receiving, from a third device based on the charging signal, a feedback signal associated with the charging signal. The feedback signal indicates at least one parameter that is detected by the third device and that is associated with the one or more time domain taps.

### BRIEF DESCRIPTION OF THE DRAWINGS

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating an example wireless communication system according to some aspects of the disclosure.

FIG. 4 is a diagram illustrating an example of one or more time domain taps associated with a charging signal according to some aspects of the disclosure.

FIG. 5 is a flow chart of a method of wireless communication according to some aspects of the disclosure.

FIG. 6 is a flow chart of another method of wireless communication according to some aspects of the disclosure.

FIG. 7 is a flow chart of another method of wireless communication according to some aspects of the disclosure.

FIG. 8 is a block diagram of an example UE according to one or more aspects.

FIG. 9 is a block diagram of an example base station according to one or more aspects.

### DETAILED DESCRIPTION

Some wireless communication networks use energy harvesting (EH) to improve performance of one or more devices. For example, a user equipment (EH) may use a charging signal transmitted by another device (such as a base station or another UE) as an energy source in addition to information/signaling to generate harvested energy. In some cases, charging signals may be dedicated transmissions for charging purposes and in other scenarios, undesired or unused wireless communication signals may be charging signals. The UE may use the harvested energy to provide charge to a battery of the UE. Additionally or alternatively, the UE may use harvested energy to power certain circuits or operations. For example, the UE may use the harvested energy to operate one or more filters, to perform data encoding or decoding, to operate one or more transmitter components (e.g., a power amplifier), or to operate one or more receiver components (e.g., a low-noise amplifier (LNA)), as illustrative examples. Devices, such as UEs, may include energy harvesting circuitry configured to convert or transduce wireless transmissions (e.g., radio frequency transmissions) into energy (e.g., power or electric voltage).

In some cases, transmission of the charging signal may interfere with a data signal received by another UE. To reduce the effects of such interference, a device transmitting the charging signal may also transmit a tracking signal indicating one or characteristics of the charging signal to enable the UE to cancel or reduce effects of the charging signal on the data signal. To illustrate, the tracking signal may include downlink control information (DCI) indicating a precoder used to precode the charging signal, and the UE may use the indication of the precoder to cancel or reduce effects of the charging signal on the data signal.

In some circumstances, use of such a tracking signal (e.g., via DCI) to cancel or reduce effects of the charging signal may be inefficient or infeasible. For example, rapidly changing channel conditions or high Doppler conditions may be associated with frequent changes of the precoder, which may be associated with high power consumption and utilization of processing resources. As another example, indicating the precoder using DCI may be performed in connection with a deterministic charging signal and may be incompatible with a random or pseudo-random charging signal. Further, use of DCI (or another signal) to indicate one or characteristics of the charging signal utilizes wireless resources of the wireless communication system.

In some aspects of the disclosure, a receiver may regenerate or reconstruct an charging signal, which may enable a UE to cancel (or reduce effects of) the charging signal from a data signal. To illustrate, a transmitting device of the charging signal generates the charging signal using a particular set of one or more time domain taps. The UE may regenerate or reconstruct the charging signal based on the particular set of one or more time domain taps and may cancel the charging signal from a data signal to reduce effects of the charging signal from the data signal.

In some examples, a UE may transmit a feedback message to the transmitting device to indicate one or more parameters of a received version of the charging signal. For example, the one or more parameters may indicate one or more parameters of the received charging signal after effects of noise, interference, or fading. In some implementations, the one or more parameters may be compressed. For example, instead of indicating each tap of a received representation of the particular set of one or more time domain taps, the one or more parameters may include a statistical mean or a variance associated with the received representation of the particular set of one or more time domain taps. In some cases, the transmitting device may adjust the charging signal based on the one or more parameters, such as by increasing a transmit power associated with the charging signal if the variance fails to satisfy (e.g., is less than) a threshold variance.

Depending on desired implementation or operational characteristics, a particular set of one or more time domain taps may be selected. Selections may be made using a deterministic technique or using a random or pseudo-random technique. In an example of deterministically generating the charging signal, the UE may use parameters associated with the charging signal to regenerate and cancel the charging signal from the data signal. In some aspects, the parameters may be indicated by the transmitting device or may be specified by a wireless communication protocol.

In an example of randomly or pseudo-randomly generating the charging signal, the UE may estimate the charging signal using a demodulation reference signal (DMRS) that is associated with the charging signal. In some aspects, the particular set of one or more time domain taps may be relatively sparse or relatively few in number, which may reduce an amount of resources used to transmit the DMRS (which may increase resources available for other signals). Further, in some aspects, resources of one or both of the charging signal or the data signal may be punctured, and the resources may be used to transmit the DMRS (which may also increase resources available for other signals).

One or more aspects described herein can aid in improving performance of one or more devices of a wireless communication system. For example, by receiving a charging signal that is based on one or more time domain taps, a UE may reconstruct such a charging signal based on an indication of the one or more time domain taps (e.g., where the one or more time domain taps are deterministically selected) or based on a DMRS (e.g., where the one or more time domain taps are randomly or pseudo-randomly selected). As a result, the UE may subtract or cancel the reconstructed charging signal from a data signal, which may reduce interference associated with the charging signal.

Innovations described herein may be used in various network architectures and in many differing types of wireless communication technologies having variously configured and sized radio networks. To further illustrate, various aspects described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km\hat{ }2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km\hat{ }2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHZ bandwidth. For other various indoor wideband implementations, using a TDD over the unlicensed portion of the 5 GHz band, the subcarrier spacing may occur with 60 kHz over a 160 MHZ bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

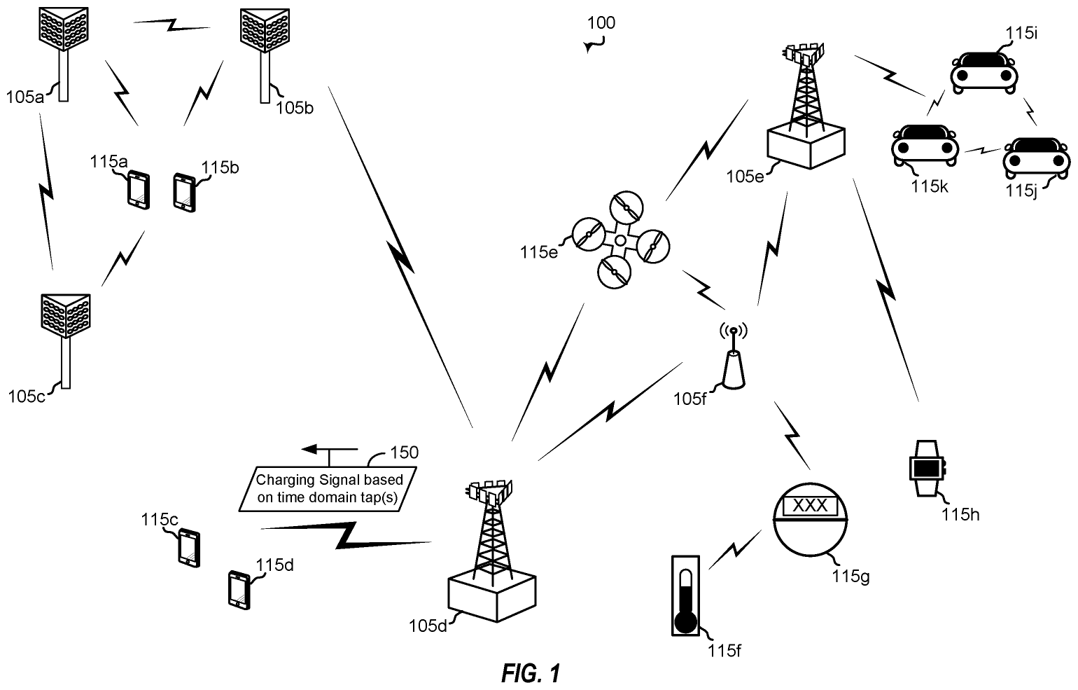

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115c, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

In some aspects, one or more devices of FIG. 1 may transmit a charging signal 150 that is based on one or more time domain taps. One or more devices within wireless charging range of the base station 105d may receive the charging signal 150. For example, the base station 105d may transmit the charging signal 150, and one or both of the UEs 115c-d may receive the charging signal 150. Alternatively or in addition, the charging signal 150 may be transmitted by one or more other devices (such as a UE), may be received by one or more other devices, or a combination thereof. In some scenarios, charging signals may be signals transmitted by devices solely intended for use as charging signals and not carry information or limited information. In other scenarios, communication signals can also be considered or used as charging signals. For example, a signal may carry information for one device yet be used as a charging signal for another device. So a charging signal can include a variety of wireless emissions and signals.

A device may use harvested energy to provide charge to a battery. Additionally or alternatively, the device may use harvested energy to power certain circuits or operations, such as to perform data encoding or decoding, to operate one or more transmitter components (e.g., a power amplifier), or to operate one or more receiver components (e.g., a low-noise amplifier (LNA)), as illustrative examples. In some cases, a network (such as the wireless network 100) may be referred to as a “self-sustainable” network in which an energy harvesting device (e.g., a UE 115) may interact within the network (or within another network) using energy harvested from one or more transmissions within the network. In some examples, such an energy source may be advantageous as compared to certain other energy sources (e.g., wind energy, solar energy, or vibrational energy) because a radio frequency (RF) energy source may be controllable and may provide relatively constant transfer. In addition, in some scenarios, an energy harvesting device may have a fixed distance from a transmitting device, in which case an amount of harvested energy may be relatively stable or predictable due to the fixed distance.

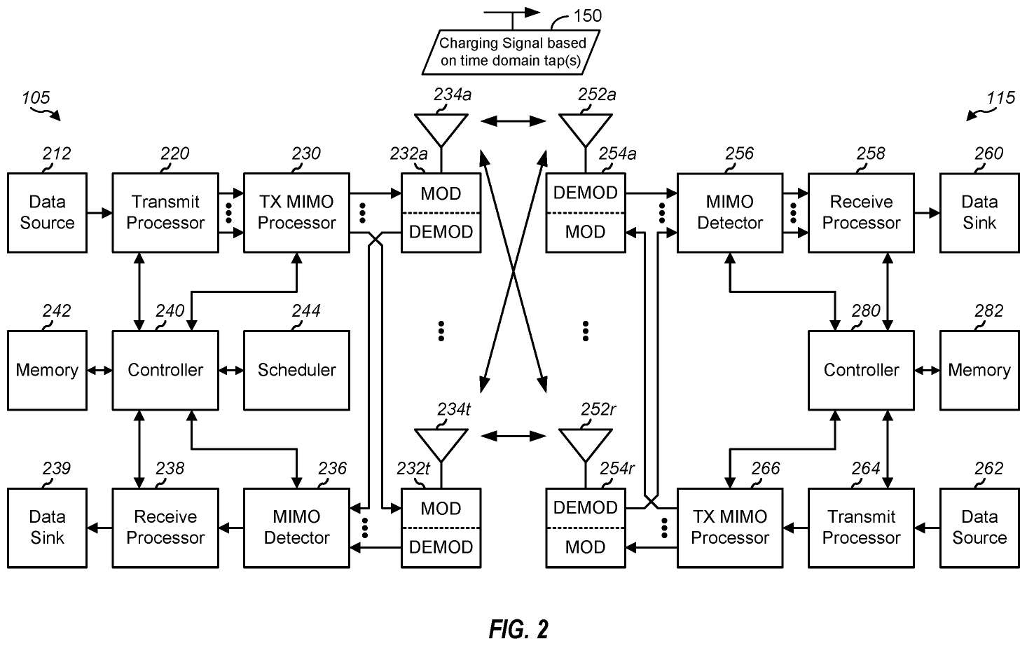

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

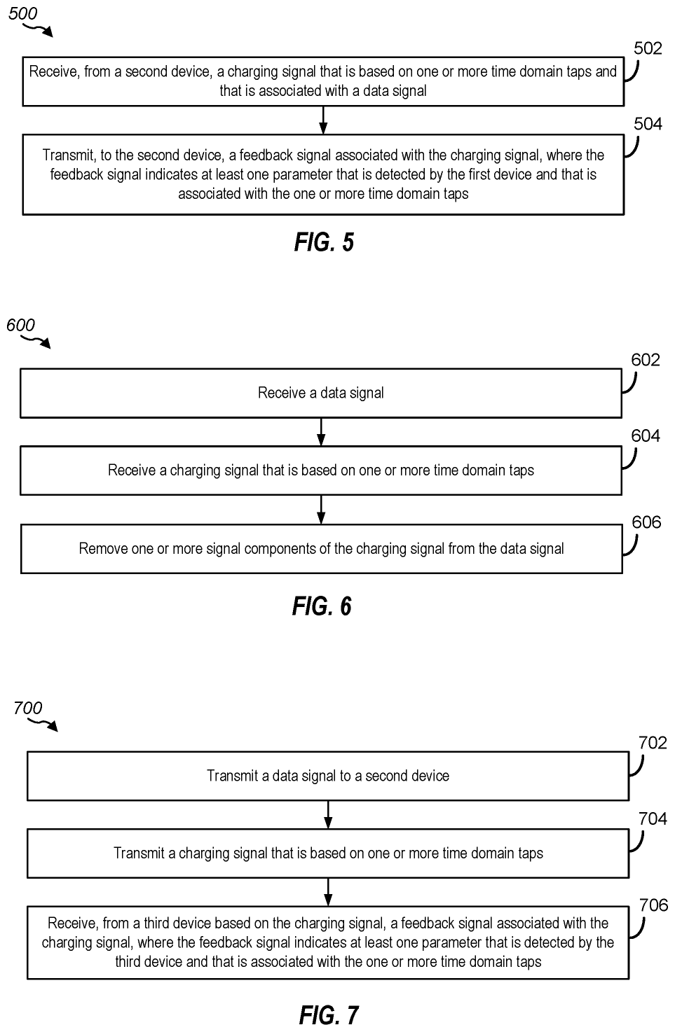

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the operations illustrated in FIGS. 5-7, to transmit or receive the charging signal 150, to perform one or more other operations, or a combination thereof. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

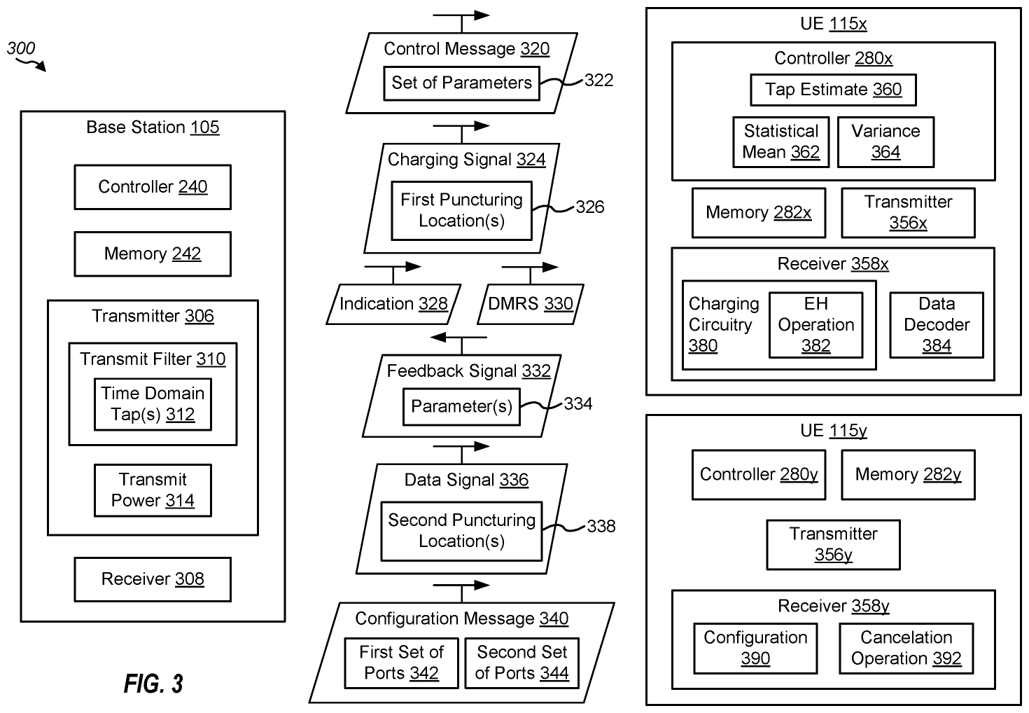

FIG. 3 is a block diagram illustrating an example of a wireless communication system 300 according to some aspects of the disclosure. The wireless communication system 300 may include one or more base stations, such as the base station 105. The wireless communication system 300 may include multiple UEs, such as a UE 115x and a UE 115y. In some examples, the UE 115x may correspond to one of the UEs 115a-k of FIG. 1, and the UE 115y may correspond to another of the UEs 115a-k of FIG. 1. In some implementations, the UE 115x may correspond to a wearable device (such as a smart watch), a low-power sensor, or another device.

The base station 105 may include one or more processors (such as the controller 240), one or more memories (such as the memory 242), a transmitter 306, and a receiver 308. The controller 240 may be coupled to the memory 242, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 306 and the receiver 308 may be integrated in one or more transceivers of the base station 105. In some other implementations, the transmitter 306 and the receiver 308 may be separate devices.

The transmitter 306 may be configured to transmit reference signals, synchronization signals, control information, and data to one or more other devices, and the receiver 308 may be configured to receive reference signals, control information, and data from one or more other devices. For example, the transmitter 306 may be configured to transmit signaling, control information, and data to the UEs 115x-y, and the receiver 308 may be configured to receive signaling, control information, and data from the UEs 115x-y.

The UEs 115x-y may each include one or more processors (such as the controller 280), a memory (such as the memory 282), a transmitter, and a receiver. For example, the UE 115x may include a controller 280x, a memory 282x, a transmitter 356x, and a receiver 358x. As another example, the UE 115y may include a controller 280y, a memory 282y, a transmitter 356y, and a receiver 358y. In some examples, the transmitters 356x and 356y and the receivers 358x and 358y may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356x and the receiver 358x may be integrated in one or more transceivers of the UE 115x, and the transmitter 356y and the receiver 358y may be integrated in one or more transceivers of the UE 115y. In some other implementations, the transmitter 356x and the receiver 358x may be separate devices, and the transmitter 356y and the receiver 358y may be separate devices.

The transmitters 356x and 356y may transmit reference signals, synchronization signals, control information, and data to one or more other devices, and the receivers 358x and 358y may receive reference signals, control information, and data from one or more other devices. For example, in some implementations, the transmitter 356x may transmit signaling, control information, and data to one or more of the base station 105 or the UE 115y, and the receiver 358x may receive signaling, control information, and data from one or more of the base station 105 or the UE 115y. As another example, in some implementations, the transmitter 356y may transmit signaling, control information, and data to one or more of the base station 105 or the UE 115x, and the receiver 358y may receive signaling, control information, and data from one or more of the base station 105 or the UE 115x.

To leverage EH operations and techniques discussed herein, communication devices (e.g., UEs) can be configured to harness and leverage energy from wireless signals (e.g., a charging signal). In some examples, one or both of the UEs 115x-y include charging circuitry 380 (e.g., an energy harvesting (EH) circuit) and a data decoder 384. In some examples, the receiver 358x includes the charging circuitry 380 and the data decoder 384. The charging circuitry 380 may perform an EH operation 382. Energy harvesting circuitry can include a converter circuit, such as alternating current (AC) and direct current (DC) (or AC/DC) converters that enable devices to transduce AC energy from wireless signaling into DC energy for use and/or storage. In some examples, a converter circuit may include a rectifier circuit, such as a diode rectifier circuit. In some implementations, a first output of a converter circuit may be coupled to a filter circuit, such as a low-pass filter circuit, which may reduce certain transient signal components (such as a “spur”) that may occur in some circumstances. A second output of the filter circuit may be coupled to provide harvested energy to one or more of a battery or other circuitry.

In some implementations, the charging circuitry 380 may be coupled to one or more of the antennas 252a-r of FIG. 2 to enable the charging circuitry 380 to perform the EH operation 382 concurrently or serially with operation of the data decoder 384. To illustrate, the charging circuitry 380 and the data decoder 384 may have one or more of a separated receiver architecture, a time-switching architecture, a power-splitting architecture, or another architecture. In some examples of a separated receiver architecture, the charging circuitry 380 may be coupled to a first subset of the antennas 252a-r, and the data decoder 384 may be coupled to a second subset of the antennas 252a-r. In such examples, the charging circuitry 380 may perform the EH operation 382 concurrently with operation of the data decoder 384. In some examples of a time-switching architecture, the charging circuitry 380 may include a time switcher circuit. The time switcher circuit may perform switching so that the EH operation 382 is performed sequentially with operation of the data decoder 384. In some examples of a power-splitting architecture, the charging circuitry 380 may include a power splitter circuit. The power splitter circuit may perform power switching so that some power of a received signal is allocated to the EH operation 382 and so that other power of the received signal is provided to the data decoder 384.

In some implementations, one or more of the transmitter 306, the receiver 308, the transmitter 356x, the transmitter 356y, the receiver 358x, or the receiver 358y may include an antenna array. The antenna array may include multiple antenna elements that perform wireless communications with other devices. In some implementations, the antenna array may perform wireless communications using different beams, also referred to as antenna beams. The beams may include transmit beams and receive beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. In some implementations, one or more sets of antenna elements of the antenna array may be configured to concurrently generate multiple beams, for example using multiple RF chains. A set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

The wireless communication system 300 may use wireless communication channels, which may be specified by one or more wireless communication protocols, such as a 5G NR wireless communication protocol. To illustrate, the base station 105 may communicate with the UEs 115x-y using one or more downlink wireless communication channels (e.g., using one or more of a PDSCH or a PDCCH) and using one or more uplink wireless communication channels (e.g., using one or more of a PUSCH or a PUCCH). In some implementations, the UEs 115x-y may communicate with one another using one or more sidelink channels, such as one or more of a sidelink control channel (e.g., a PSCCH), a sidelink data channel (e.g., a PSSCH), or a sidelink feedback channel (e.g., a PSFCH).

During operation, the base station 105 may transmit a charging signal 324 (e.g., the charging signal 150 or another charging signal). In some examples, the charging signal 324 may also be referred to as an EH signal, an EH waveform, or a wireless charging signal. To illustrate, in some examples, the charging signal 324 may include an energy signal that does not include encoded data or information. Alternatively or in addition, the charging signal 324 may include one or more other signals, such as “ambient” data signals transmitted to one or more other devices (such as the UE 115y) within the wireless communication network 300.

In some circumstances, a base station (such as the base station 105 or another base station) may transmit a data signal 336. To illustrate, the base station 105 may transmit the data signal 336 to a particular device, such as the UE 115x or the UE 115y. As referred to herein, the data signal 336 may include or correspond to data (e.g., user data), control information (such as scheduling information, resource allocation information, or other control information), reference signaling, other information, or a combination thereof.

In some implementations, the base station 105 may concurrently transmit the charging signal 324 and the data signal 336, such as using a beamforming technique (e.g., by transmitting the charging signal 324 using a first beam and by transmitting the data signal 336 using a second beam that is different than the first beam). To further illustrate, the base station 105 may concurrently transmit the charging signal 324 and the data signal 336 using a simultaneous wireless information and power transfer (SWIPT) technique. In some implementations, the base station 105 precodes the charging signal 324 and the data signal 336 using different respective precoders.

The charging signal 324 may be received by one or more devices (such as the UE 115x) within a wireless charging range of the base station 105. In some examples, the charging signal 324 and the data signal 336 are received by the UE 115x as a received signal according to Equation 1:

$$Y = HF 1 s\_data + HF 2 s\_energy . \qquad ( Equation 1 )$$

In Equation 1, Y may correspond to a frequency domain representation of the received signal, H may correspond to a channel response of one or more wireless communication channels used to transmit the charging signal 324 and the data signal 336, F1 may correspond to a first precoder used by the base station 105 to precode the data signal 336, F2 may correspond to a second precoder used by the base station 105 to precode the charging signal 324, s_data may correspond to the transmitted version of the data signal 336, and s_energy may correspond to the transmitted version of the charging signal 324.

The UE 115x may receive the charging signal 324 (such as by receiving the received signal Y of Equation 1) and may use the charging signal 324 to perform energy harvesting (such as by performing the EH operation 382). An example of the EH operation 382 is battery charging (such as by charging, or partially charging, a battery that may be included in the UE 115x). In some other examples, power generated using the EH operation 382 may be provided directly to one or more components of the UE 115x (alternatively or in addition to charging a battery of the UE 115x). For example, the EH operation 382 may include using harvested energy from the charging signal 324 to operate one or more filters, to perform data encoding or decoding, to operate one or more components of the transmitter 356x (e.g., a power amplifier), or to operate one or more components of the receiver 358x (e.g., a low-noise amplifier (LNA)), as illustrative examples.

In some aspects of the disclosure, the base station 105 may generate the charging signal 324 based on one or more time domain taps 312. A time domain tap may also be referred to herein as a time domain filter coefficient or a time domain filter tap. In some examples, the base station 105 generates the charging signal 324 by applying a power signal from a power source to a transmit filter 310 that may be included in the transmitter 306. The transmit filter 310 may have filter response that corresponds to or that is based on the one or more time domain taps 312, which may cause the charging signal 324 to have a time domain waveform that is based on the one or more time domain taps 312. To further illustrate, the charging signal 324 may be based on one or more of a number of the one or more time domain taps 312, a location of at least one of the one or more time domain taps 312, a transmit power 314 of at least one of the one or more time domain taps, or a distribution associated with the one or more time domain taps 312.

In some examples, the base station 105 may deterministically generate the charging signal 324 based on a set of parameters 322. The set of parameters 322 may include the one or more time domain taps 312, one or more other parameters, or a combination thereof. In some examples, the set of parameters 322 is common to a plurality of user equipment (UE) devices including the UE 115x. In some implementations, the base station 105 may transmit to the UE 115x a control message 320 indicating the set of parameters 322. The control message 320 may include or correspond to a configuration message, a medium access control (MAC) control element (MAC-CE) message, downlink control information (DCI), or a sidelink resource pool configuration message, as illustrative examples. Alternatively or in addition, the set of parameters 322 may be specified by a wireless communication protocol.

In some other examples, the base station 105 may generate the charging signal 324 randomly or pseudo-randomly. For example, the base station 105 may randomly or pseudo-randomly select the one or more time domain taps 312, such as by randomly or pseudo-randomly select the one or more time domain taps 312 from a set of candidate time domain taps. In some such examples, the set of parameters 322 may include or correspond to the set of candidate time domain taps.

The UE 115x may receive the charging signal 324. The charging circuitry 380 may perform the EH operation 382 based on the charging signal 324. For example, the charging circuitry 380 may perform the EH operation 382 based on the charging signal 324 using one or more of a separated receiver architecture based technique, a time-switching architecture based technique, a power-splitting architecture based technique, or another technique.

In some aspects of the disclosure, the charging circuitry 380 may determine one or more values with associated with the charging signal 324. To illustrate, in some examples, the charging circuitry 380 may include an analog-to-digital converter (ADC) circuit that digitizes the charging signal 324 to generate the one or more values. The charging circuitry 380 may also include a buffer that stores the one or more values, and the controller 280x may retrieve the one or more values from the buffer.

The controller 280x may determine (e.g., based on the retrieved one or more values) a tap estimate 360 of the one or more time domain taps 312. For example, determining the tap estimate 360 may include determining a frequency spectrum associated with the retrieved one or more values and performing an inverse Fourier transform operation based on the frequency spectrum to determine the tap estimate 360. Alternatively or in addition, the base station 105 may transmit a demodulation reference signal (DMRS) 330 associated with the charging signal 324 to enable the UE 115x to estimate the charging signal 324.

The tap estimate 360 may include or correspond to a representation of the one or more time domain taps 312 that differs from the one or more time domain taps 312 due to noise or interference associated with transmission and reception of the charging signal 324. As a result, at least one tap indicated by the tap estimate 360 may differ from a corresponding tap of the one or more time domain taps 312.

The controller 280x may determine (e.g., based on the tap estimate 360) one or more parameters 334 that are associated with the one or more time domain taps 312 (or that are associated with the tap estimate 360 of the one or more time domain taps 312). For example, the one or more parameters 334 may include one or more of a statistical mean 362 associated with the one or more time domain taps or a variance 364 associated with the one or more time domain taps. In some examples, the variance 364 may be associated with or may correspond to a received power associated with the one or more time domain taps 312.

The UE 115x may transmit, to the base station 105, a feedback signal 332 indicating the one or more parameters 334. The base station 105 may receive the feedback signal 332 and may perform one or more operations based on the feedback signal 332, such as by adjusting the one or more time domain taps 312. As an example, the base station 105 may adjust one or more of a number (or cardinality) of the one or more time domain taps 312, a location of at least one of the one or more time domain taps 312, the transmit power 314 of at least one of the one or more time domain taps 312, or a distribution associated with the one or more time domain taps 312. In some examples, the base station 105 may transmit to the UE 115x an indication 328 modifying the one or more time domain taps 312. As an illustrative example, the indication 328 may modify a number (or cardinality) of the one or more time domain taps 312 to change an energy level associated with the charging signal 324.

In some aspects of the disclosure, the charging signal 324 may be punctured at one or more first puncturing locations 326 to enable transmission of at least a first portion of the DMRS 330. For example, the base station 105 may reassign particular resources from the charging signal 324 to the DMRS 330 and may transmit at least the first portion of the DMRS 330 using the particular resources. In some examples, a first number (or cardinality) of the one or more first puncturing locations 326 is based on a second number (or cardinality) of the one or more time domain taps 312.

The UE 115x may receive the DMRS 330. In some examples, the UE 115x uses the DMRS to determine the tap estimate 360. For example, the UE 115x may use the DMRS to determine a channel response associated with a wireless channel used to transmit the charging signal 324 and may use the channel response to determine the tap estimate 360.

In addition to using the DMRS 330 to determine the tap estimate 360, in some examples, the UE 115x uses the DMRS 330 to perform the EH operation 382. In such examples, the UE 115x may perform the EH operation 382 based on energy supplied from both the charging signal 324 and the DMRS 330 (e.g., by charging a battery based on energy supplied from both the charging signal 324 and the DMRS 330, by supplying power to one or more other components based on energy supplied from both the charging signal 324 and the DMRS 330, or both).

In some examples, particular resources associated with the data signal 336 may be used to transmit at least a portion of the DMRS 330. For example, the data signal 336 may punctured at one or more second puncturing locations 338 to enable transmission of at least a second portion of the DMRS 330. In such examples, the base station 105 may reassign the particular resources from the data signal 336 to the DMRS 330 and may transmit at least the second portion of the DMRS 330 using the particular resources. Accordingly, the base station 105 may transmit the DMRS 330 by puncturing the charging signal 324, the data signal 336, or both.

Accordingly, one or more devices (such as the UE 115x) may perform energy harvesting based on the charging signal 324. In some circumstances, one or more devices may experience interference due to the charging signal 324. For example, one or more UEs 115 receiving the data signal 336 may experience interference due to the charging signal 324, such as if the base station 105 concurrently transmits the charging signal 324 and the data signal 336 using a SWIPT technique. To reduce or cancel interference due to the charging signal 324, one or more UEs 115 may perform a cancelation operation 392 to cancel (or reduce) one or more signal components of the charging signal 324 from the data signal 336. Depending on the example, the one or more UEs 115 may include a UE that performs EH (such as the UE 115x) or another UE. For example, in some implementations, the UE 115y may have a non-EH configuration that does not include charging circuitry 380. As a result, the charging signal 324 may contribute noise or interference to one or more other signals received by the UE 115y, such as the data signal 336.

In some aspects of the disclosure, the UE 115y uses one or more characteristics of the charging signal 324 to perform the cancelation operation 392 to cancel (or reduce) one or more signal components of the charging signal 324 from the data signal 336. To illustrate, the UE 115y may receive (e.g., from the base station 105) a configuration 390 indicating that the one or more puncturing locations are reserved for the DMRS 330. The one or more puncturing locations may include the first puncturing locations 326, the second puncturing locations 338, or both. Based on the one or more puncturing locations, the UE 115y may demodulate the charging signal 324 using the DMRS 330. The UE 115y may cancel (or remove, or reduce) the demodulated charging signal 324 from the data signal 336 to generate a representation of the data signal 336 and may demodulate the representation of the data signal (e.g., to generate data that is represented by the data signal 336).

Accordingly, in some aspects of the disclosure, one or more devices (such as the UE 115x) may perform EH based on the charging signal 324 and the DMRS 330, and one or more devices (such as the UE 115y) may perform cancelation of the charging signal 324 based on the DMRS 330. In some examples, the base station 105 generates the charging signal 324 based on the set of parameters 322 (e.g., using a deterministic technique). The UE 115y may receive the control message 320 and may reconstruct the charging signal 324 based on the set of parameters 322 (e.g., by reconstructing the one or more time domain taps 312 based on the set of parameters 322) and may subtract the reconstructed charging signal 324 from the data signal 336.

In some other examples, the UE 115x may reconstruct the charging signal 324 using one or more other techniques, such as based on the DMRS 330 (e.g., in connection with a random or pseudo-random generation of the charging signal 324). For example, the UE 115y may use the DMRS 330 to reconstruct the charging signal 324 and may subtract the reconstructed charging signal 324 from the data signal 336.

In some aspects, the base station 105 may configure a particular device with one or both of a first set of ports 342 or a second set of ports 344. The first set of ports 342 may be for receiving the DMRS 330 to enable energy harvesting based on the charging signal 324, and the second set of ports 344 may be for receiving the DMRS 330 to enable cancelation of the charging signal 324 from the data signal 336. For example, the UE 115x may receive the DMRS 330 using the first set of ports 342, and the UE 115y may receive the DMRS 330 using the second set of ports 342. The base station 105 may configure the UEs 115x-y with the first set of ports 342 and the second set of ports 344 by transmitting a configuration message 340 (e.g., an RRC configuration message).

In some examples, the UE 115x may report to the base station 105 (e.g., via the one or more parameters 334 of the feedback signal 332) cross-tap correlation data associated with the tap estimate 360. To illustrate, the cross-tap correlation data may include a mean vector for taps of the tap estimate 360 or a covariance matrix of taps of the tap estimate 360. The base station 105 may use the cross-tap correlation data to adjust the one or more time domain taps 312 used to generate the charging signal 324. In some examples, the one or more time domain taps 312 include taps that generated independently of one another. In such examples, a covariance of a particular tap with itself may correspond to the variance 364, and a covariance of the particular tap with another tap may correspond to zero. To further illustrate, the one or more time domain taps 312 may be generated using independent parameters, such as random variables generated using a mean and a variance associated with the one or more time domain taps 312. In some other implementations, the one or more time domain taps 312 may be generated randomly or pseudo-randomly.

Although the base station 105 has been described in some examples as a single device or entity, it is noted that operations of the base station 105 may be performed by multiple devices or entities in some implementations. To illustrate, in some examples, the charging signal 324 and the data signal 336 may be transmitted by different base stations. In some examples of an open radio access network (ORAN) implementation, operations of the base station 105 may be performed using a radio unit (RU) device, a distributed unit (DU) device, and a centralized unit (CU) device. In some implementations, the RU device may transmit wireless communication signals to and receive wireless communication signals from the UEs 115x-y, and one or more of the DU device or the CU device may perform other operations, such as communications with a core network. A communication link between the RU device and the DU device may be referred to as a fronthaul communication link. A communication link between the DU device the CU device may be referred to as a midhaul communication link. A communication link between the CU device and the core network may be referred to as a backhaul communication link. Those of skill in the art will appreciate that other examples of an ORAN or other implementation are also within the scope of the disclosure.

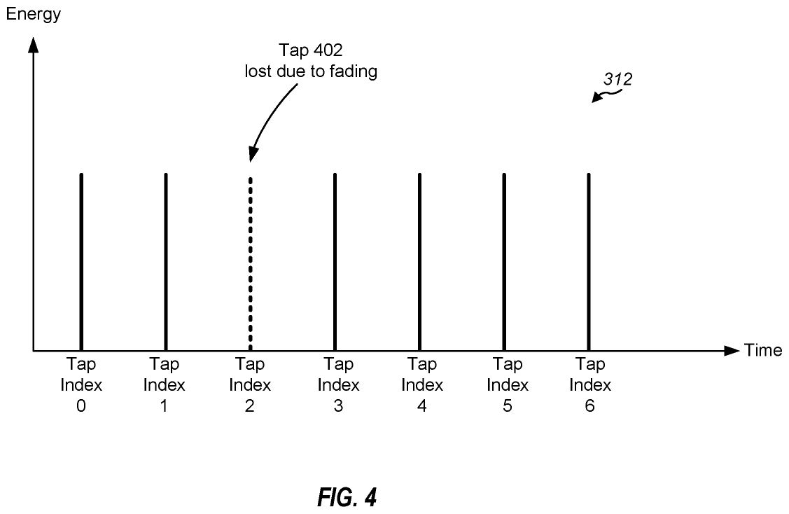

FIG. 4 is a diagram illustrating an example of the one or more time domain taps 312 associated with the charging signal 324 according to some aspects of the disclosure. In the example of FIG. 4, the one or more time domain taps 312 may include or correspond to a set of seven taps (which may have tap indices of 0, 1, 2, 3, 4, 5, and 6). In other examples, the one or more time domain taps 312 may include or correspond to a different number of taps. As an example, the one or more time domain taps 312 may correspond to a single tap, in which case the charging signal 324 may be constant or approximately constant in the frequency domain across tones used to transmit the charging signal 324. Further, it should be appreciated that the example of the charging signal 324 illustrated in FIG. 4 may be repeated (e.g., based on a periodic repetition pattern).

In some circumstances, a number (or cardinality) of taps of the one or more time domain taps 312 may be selected based on one or more criteria, such as based on channel conditions associated with a wireless communication system. To illustrate, in some circumstances, a tap 402 may be “lost” due to fading, in which case the one or more parameters 334 may indicate or reflect loss of the tap 402. As an example, the base station 105 may detect that the variance 364 exceeds a variance threshold. In some examples, the base station 105 may adjust the number of taps of the one or more time domain taps 312 based on loss of the tap 402 (e.g., by increasing the number of taps to increase an amount of energy associated with the charging signal 324, which may be indicated via the indication 328).

Although certain operations have been described separately with respect to the UEs 115x-y, in some implementations, such operations may be implemented by a single UE. For example, a UE (e.g., the UE 115x or the UE 115y) may perform both the EH operation 382 and the cancelation operation 392 in some implementations.

Although certain operations have been described with reference to the base station 105, in some other examples, such operations may be performed by a UE in connection with a sidelink implementation. For example, although generation of the charging signal 324 has been described with reference to the base station 105, in some other examples, another device may transmit a charging signal. As an illustrative example, the UE 115y may transmit the charging signal 324 to the UE 115x via a sidelink communication channel.

One or more aspects described herein may improve performance of one or more devices of a wireless communication system, such as the wireless communication system 300. For example, by generating the charging signal 324 using the one or more time domain taps 312, a UE may reconstruct the charging signal 324 based on the set of parameters 322 (e.g., where the one or more time domain taps 312 are deterministically selected) or based on the DMRS 330 (e.g., where the one or more time domain taps 312 are randomly or pseudo-randomly selected). As a result, the UE may subtract or cancel the charging signal 324 from the data signal 336, which may reduce interference associated with the charging signal 324.

In some cases, a network (such as the wireless communication network 300) may be referred to as a “self-sustainable” network in which an energy harvesting device (e.g., a UE 115) may interact within the network (or within another network) using energy harvested from one or more transmissions within the network. In some examples, such an energy source may be advantageous as compared to certain other energy sources (e.g., wind energy, solar energy, or vibrational energy) because a radio frequency (RF) energy source may be controllable and may provide relatively constant transfer. In addition, in some scenarios, an energy harvesting device may have a fixed distance from a transmitting device, in which case an amount of harvested energy may be relatively stable or predictable due to the fixed distance.

FIG. 5 is a flow chart illustrating an example of method 500 of wireless communication performed by a first device according to some aspects. In some examples, the method 500 may be performed by a UE, such as the UE 115x. In some other examples, the method 500 may be performed by another device, such as a base station (e.g., the base station 105).

The method 500 includes receiving, from a second device, a charging signal that is based on one or more time domain taps and that is associated with a data signal, at 502. For example, the UE 115x may use the receiver 358x to receive the charging signal 324 from the base station 105. The charging signal 324 may be based on the one or more time domain taps 312 and may be associated with the data signal 336.

The method 500 further includes transmitting, to the second device, a feedback signal associated with the charging signal, at 504. The feedback signal indicates at least one parameter that is detected by the first device and that is associated with the one or more time domain taps. For example, the UE 115x may use the transmitter 356x to transmit the feedback signal 332 indicating the one or more parameters 334.

FIG. 6 is a flow chart illustrating an example of method 600 of wireless communication performed by a first device according to some aspects. In some examples, the method 600 may be performed by a UE, such as the UE 115y. In some other examples, the method 600 may be performed by another device, such as a base station (e.g., the base station 105).

The method 600 includes receiving a data signal, at 602. For example, the UE 115y may use the receiver 358y to receive the data signal 336 from the base station 105.

The method 600 further includes receiving a charging signal that is based on one or more time domain taps, at 604. For example, the UE 115y may use the receiver 358y to receive the charging signal 324 from the base station 105.

The method 600 further includes removing one or more signal components of the charging signal from the data signal, at 606. For example, the UE 115y may use the receiver 358y to remove one or more signal components of the charging signal 324 from the data signal 336.

FIG. 7 is a flow chart illustrating an example of method 700 of wireless communication performed by a first device according to some aspects. In some examples, the method 700 may be performed by a base station, such as the base station 105. In some other examples, the method 700 may be performed by another device, such as a UE (e.g., the UE 115x or the UE 115y).

The method 700 includes transmitting a data signal to a second device, at 702. For example, the base station 105 may transmit the data signal 336 to the UE 115y.

The method 700 further includes transmitting a charging signal that is based on one or more time domain taps, at 704. For example, the base station 105 may transmit the charging signal 324 based on the one or more time domain taps 312.

The method 700 further includes receiving, from a third device based on the charging signal, a feedback signal associated with the charging signal, at 706. The feedback signal indicates at least one parameter that is detected by the third device and that is associated with the one or more time domain taps. For example, the base station 105 may receive the feedback signal 332 from the UE 115x. The feedback signal 332 may indicate the one or more parameters 334.

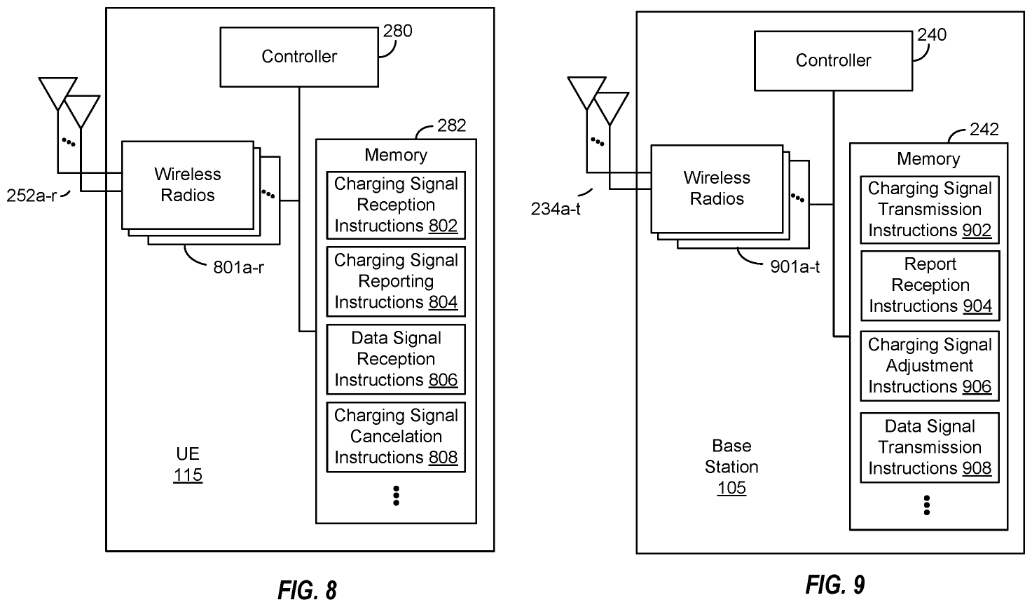

FIG. 8 is a block diagram illustrating an example of the UE 115 according to some aspects of the disclosure. The UE 115 may include structure, hardware, or components illustrated in FIG. 2. For example, the UE 115 may include the controller 280, which may execute instructions stored in the memory 282. Using the controller 280, the UE 115 may transmit and receive signals via wireless radios 801a-r and antennas 252a-r. The wireless radios 801a-r may include one or more components or devices described herein, such as the modulator/demodulators 254a-r, the MIMO detector 256, the receive processor 258, the transmit processor 264, the TX MIMO processor 266, the transmitter 356x, the transmitter 356y, the receiver 358x, the receiver 358y, one or more other components or devices, or a combination thereof.

In some implementations, the memory 282 may store instructions executable by one or more processors (e.g., the controller 280) to initiate, perform, or control one or more operations described herein. For example, the memory 282 may store charging signal reception instructions 802 executable by the controller 280 to initiate, control, or perform reception of the charging signal 324. As another example, the memory 282 may store charging signal reporting instructions 804 executable by the controller 280 to initiate, control, or perform determination of the one or more parameters 334 and transmission of the feedback signal 332. Alternatively or in addition, the memory 282 may store data reception instructions 806 executable by the controller 280 to initiate, control, or perform reception of the data signal 336 and cancelation instructions 808 executable by the controller 280 to initiate, control, or perform cancelation of the charging signal 324 from the data signal 336.

FIG. 9 is a block diagram illustrating an example of the base station 105 according to some aspects of the disclosure. The base station 105 may include structure, hardware, and components illustrated in FIG. 2. For example, the base station 105 may include the controller 240, which may execute instructions stored in memory 242. Under control of the controller 240, the base station 105 may transmit and receive signals via wireless radios 901a-t and antennas 234a-t. The wireless radios 901a-t may include one or more components or devices described herein, such as the modulator/demodulators 232a-t, the MIMO detector 236, the receive processor 238, the transmit processor 220, the TX MIMO processor 230, the transmitter 306, the receiver 308, one or more other components or devices, or a combination thereof.

In some implementations, the memory 242 may store instructions executable by one or more processors (e.g., the controller 240) to initiate, perform, or control one or more operations described herein. For example, the memory 242 may store charging signal transmission instructions 902 executable by the controller 240 to initiate, control, or perform transmission of the charging signal 324. As another example, the memory 242 may store report reception instructions 904 executable by the controller 240 to initiate, control, or perform reception of the feedback signal 332. As an additional example, the memory 242 may store charging signal adjustment instructions 906 executable by the controller 240 to initiate, control, or perform adjustment of the charging signal 324 based on the one or more parameters 334 indicated by the feedback signal 332. The example of FIG. 9 also illustrates that the memory 242 may store data signal transmission instructions 908 executable by the controller 240 to initiate, control, or perform transmission of the data signal 336.

According to some further aspects, in a first aspect, an apparatus for wireless communication includes a receiver configured to receive, from a device, a charging signal that is based on one or more time domain taps and that is associated with a data signal. The apparatus further includes a transmitter configured to transmit, to the device, a feedback signal associated with the charging signal. The feedback signal indicates at least one parameter that is detected by the apparatus and that is associated with the one or more time domain taps.

In a second aspect alternatively or in addition to the first aspect, the at least one parameter includes one or more of a statistical mean associated with the one or more time domain taps, a variance associated with the one or more time domain taps, or cross-tap correlation data associated with the one or more time domain taps, and the cross-tap correlation data includes one or more of a mean vector or a covariance matrix.

In a third aspect alternatively or in addition to one or more of the first through second aspects, the charging signal is based on one or more of a number of the one or more time domain taps, a location of at least one of the one or more time domain taps, a power of at least one of the one or more time domain taps, or a distribution associated with the one or more time domain taps.

In a fourth aspect alternatively or in addition to one or more of the first through third aspects, the receiver is further configured to receive an indication modifying a number of the one or more time domain taps to change an energy level associated with the charging signal.

In a fifth aspect alternatively or in addition to one or more of the first through fourth aspects, the charging signal is punctured at one or more first puncturing locations to enable transmission of at least a first portion of a demodulation reference signal (DMRS) to enable estimation of the charging signal.

In a sixth aspect alternatively or in addition to one or more of the first through fifth aspects, a first number of the one or more first puncturing locations is based on a second number of the one or more time domain taps.

In a seventh aspect alternatively or in addition to one or more of the first through sixth aspects, the apparatus includes energy harvesting (EH) circuitry configured to perform an EH operation based on energy supplied from both the charging signal and the DMRS. The EH circuitry includes a converter circuit configured to transduce alternating current (AC) energy to direct current (DC) energy and a filter circuit coupled to a first output of the converter circuit. A second output of the filter circuit is coupled to provide harvested energy to one or more of a battery or other circuitry.

In an eighth aspect alternatively or in addition to one or more of the first through seventh aspects, the receiver is further configured to receive, from the device, a configuration message configuring the first device with one or more of a first set of ports for receiving the DMRS to enable energy harvesting based on the charging signal or a second set of ports for receiving the DMRS to enable cancelation of the charging signal from the data signal.

In a ninth aspect alternatively or in addition to one or more of the first through eighth aspects, the data signal is punctured at one or more second puncturing locations to enable transmission of at least a second portion of the DMRS.

In a tenth aspect alternatively or in addition to one or more of the first through ninth aspects, a method of wireless communication performed by a first device includes receiving, from a second device, a charging signal that is based on one or more time domain taps and that is associated with a data signal. The method further includes transmitting, to the second device, a feedback signal associated with the charging signal. The feedback signal indicates at least one parameter that is detected by the first device and that is associated with the one or more time domain taps.

In an eleventh aspect alternatively or in addition to one or more of the first through tenth aspects, the at least one parameter includes one or more of a statistical mean associated with the one or more time domain taps, a variance associated with the one or more time domain taps, or cross-tap correlation data associated with the one or more time domain taps, and the cross-tap correlation data includes one or more of a mean vector or a covariance matrix.

In a twelfth aspect alternatively or in addition to one or more of the first through eleventh aspects, the charging signal is based on one or more of a number of the one or more time domain taps, a location of at least one of the one or more time domain taps, a power of at least one of the one or more time domain taps, or a distribution associated with the one or more time domain taps.

In a thirteenth aspect alternatively or in addition to one or more of the first through twelfth aspects, an apparatus for wireless communication includes a transmitter and a receiver configured to receive a data signal. The receiver is further configured to receive a charging signal that is based on one or more time domain taps and to remove one or more signal components of the charging signal from the data signal.

In a fourteenth aspect alternatively or in addition to one or more of the first through thirteenth aspects, the charging signal is based on one or more of a number of the one or more time domain taps, a location of at least one of the one or more time domain taps, a transmit power of at least one of the one or more time domain taps, or a distribution associated with the one or more time domain taps.

In a fifteenth aspect alternatively or in addition to one or more of the first through fourteenth aspects, the charging signal is punctured at one or more first puncturing locations to enable transmission of at least a first portion of a demodulation reference signal (DMRS) to enable estimation of the charging signal.

In a sixteenth aspect alternatively or in addition to one or more of the first through fifteenth aspects, a first number of the one or more first puncturing locations is based on a second number of the one or more time domain taps.

In a seventeenth aspect alternatively or in addition to one or more of the first through sixteenth aspects, the receiver is further configured to receive a configuration indicating that the one or more first puncturing locations are reserved for the DMRS, to demodulate, based on the one or more first puncturing locations, the charging signal using the DMRS, where removing the one or more signal components includes removing the demodulated charging signal from the data signal to generate a representation of the data signal, and to demodulate the representation of the data signal.

In an eighteenth aspect alternatively or in addition to one or more of the first through seventeenth aspects, the receiver is further configured to receive a configuration message configuring the apparatus with one or more of a first set of ports for receiving the DMRS to enable energy harvesting based on the charging signal or a second set of ports for receiving the DMRS to enable cancelation of the charging signal from the data signal.

In a nineteenth aspect alternatively or in addition to one or more of the first through eighteenth aspects, the data signal is punctured at one or more second puncturing locations to enable transmission of at least a second portion of the DMRS.

In a twentieth aspect alternatively or in addition to one or more of the first through nineteenth aspects, a method of wireless communication performed by a first device includes transmitting a data signal to a second device. The method further includes transmitting a charging signal that is based on one or more time domain taps and receiving, from a third device based on the charging signal, a feedback signal associated with the charging signal. The feedback signal indicates at least one parameter that is detected by the third device and that is associated with the one or more time domain taps.

In a twenty-first aspect alternatively or in addition to one or more of the first through twentieth aspects, the at least one parameter includes one or more of a statistical mean associated with the one or more time domain taps, a variance associated with the one or more time domain taps, or cross-tap correlation data associated with the one or more time domain taps, and the cross-tap correlation data includes one or more of a mean vector or a covariance matrix.

In a twenty-second aspect alternatively or in addition to one or more of the first through twenty-first aspects, the charging signal is based on one or more of a number of the one or more time domain taps, a location of at least one of the one or more time domain taps, a transmit power of at least one of the one or more time domain taps, or a distribution associated with the one or more time domain taps.

In a twenty-third aspect alternatively or in addition to one or more of the first through twenty-second aspects, the method includes transmitting an indication modifying a number of the one or more time domain taps to change an energy level associated with the charging signal.

In a twenty-fourth aspect alternatively or in addition to one or more of the first through twenty-third aspects, the charging signal is deterministically generated by the first device based on a set of parameters that are common to a plurality of user equipment (UE) devices including the second device, that are specified by a wireless communication protocol, or both.

In a twenty-fifth aspect alternatively or in addition to one or more of the first through twenty-fourth aspects, the method includes transmitting a control message indicating the set of parameters, and the control message includes a configuration message, a medium access control (MAC) control element (MAC-CE) message, downlink control information, or a sidelink resource pool configuration message.

In a twenty-sixth aspect alternatively or in addition to one or more of the first through twenty-fifth aspects, the charging signal is randomly or pseudo-randomly generated by the first device.

In a twenty-seventh aspect alternatively or in addition to one or more of the first through twenty-sixth aspects, the charging signal is punctured at one or more first puncturing locations to enable transmission of at least a first portion of a demodulation reference signal (DMRS) to enable estimation of the charging signal.

In a twenty-eighth aspect alternatively or in addition to one or more of the first through twenty-seventh aspects, a first number of the one or more first puncturing locations is based on a second number of the one or more time domain taps.

In a twenty-ninth aspect alternatively or in addition to one or more of the first through twenty-eighth aspects, the method includes transmitting a configuration message indicating one or more of a first set of ports for receiving the DMRS to enable energy harvesting based on the charging signal or a second set of ports for receiving the DMRS to enable cancelation of the charging signal from the data signal.

In a thirtieth aspect alternatively or in addition to one or more of the first through twenty-ninth aspects, the data signal is punctured at one or more second puncturing locations to enable transmission of at least a second portion of the DMRS.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, the functional blocks, and the modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

The various illustrative logics, logical blocks, modules, circuits and processes described herein may be implemented as electronic hardware, computer software, or combinations of both. Whether such functionality is implemented in hardware or software may depend upon the particular application and design of the overall system.

A hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. A storage medium may be any available medium that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication, the apparatus comprising:
a receiver configured to receive, from a device, a charging signal that is based on one or more time domain taps and that is associated with a data signal; and
a transmitter configured to transmit, to the device, a feedback signal associated with the charging signal, wherein the feedback signal indicates at least one parameter that is detected by the apparatus and that is associated with the one or more time domain taps.

2. The apparatus of claim 1, wherein the at least one parameter includes one or more of a statistical mean associated with the one or more time domain taps, a variance associated with the one or more time domain taps, or cross-tap correlation data associated with the one or more time domain taps, and wherein the cross-tap correlation data includes one or more of a mean vector or a covariance matrix.

3. The apparatus of claim 1, wherein the charging signal is based on one or more of a number of the one or more time domain taps, a location of at least one of the one or more time domain taps, a power of at least one of the one or more time domain taps, or a distribution associated with the one or more time domain taps.

4. The apparatus of claim 1, wherein the receiver is further configured to receive an indication modifying a number of the one or more time domain taps to change an energy level associated with the charging signal.

5. The apparatus of claim 1, wherein the charging signal is punctured at one or more first puncturing locations to enable transmission of at least a first portion of a demodulation reference signal (DMRS) to enable estimation of the charging signal.

6. The apparatus of claim 5, wherein a first number of the one or more first puncturing locations is based on a second number of the one or more time domain taps.

7. The apparatus of claim 5, wherein the apparatus comprises energy harvesting (EH) circuitry configured to perform an EH operation based on energy supplied from both the charging signal and the DMRS, and wherein the EH circuitry comprises:
a converter circuit configured to transduce alternating current (AC) energy to direct current (DC) energy; and
a filter circuit coupled to a first output of the converter circuit, wherein a second output of the filter circuit is coupled to provide harvested energy to one or more of a battery or other circuitry.

8. The apparatus of claim 5, wherein the receiver is further configured to receive, from the device, a configuration message configuring the apparatus with one or more of:
a first set of ports for receiving the DMRS to enable energy harvesting based on the charging signal; or
a second set of ports for receiving the DMRS to enable cancelation of the charging signal from the data signal.

9. The apparatus of claim 5, wherein the data signal is punctured at one or more second puncturing locations to enable transmission of at least a second portion of the DMRS.

10. A method of wireless communication performed by a first device, the method comprising:
receiving, from a second device, a charging signal that is based on one or more time domain taps and that is associated with a data signal; and
transmitting, to the second device, a feedback signal associated with the charging signal, wherein the feedback signal indicates at least one parameter that is detected by the first device and that is associated with the one or more time domain taps.

11. The method of claim 10, wherein the at least one parameter includes one or more of a statistical mean associated with the one or more time domain taps, a variance associated with the one or more time domain taps, or cross-tap correlation data associated with the one or more time domain taps, and wherein the cross-tap correlation data includes one or more of a mean vector or a covariance matrix.

12. The method of claim 10, wherein the charging signal is based on one or more of a number of the one or more time domain taps, a location of at least one of the one or more time domain taps, a power of at least one of the one or more time domain taps, or a distribution associated with the one or more time domain taps.

13. An apparatus for wireless communication, the apparatus comprising:
a transmitter; and
a receiver configured to:
receive a data signal;
receive a charging signal that is based on one or more time domain taps; and
remove one or more signal components of the charging signal from the data signal.

14. The apparatus of claim 13, wherein the charging signal is based on one or more of a number of the one or more time domain taps, a location of at least one of the one or more time domain taps, a transmit power of at least one of the one or more time domain taps, or a distribution associated with the one or more time domain taps.

15. The apparatus of claim 13, wherein the charging signal is punctured at one or more first puncturing locations to enable transmission of at least a first portion of a demodulation reference signal (DMRS) to enable estimation of the charging signal.

16. The apparatus of claim 15, wherein a first number of the one or more first puncturing locations is based on a second number of the one or more time domain taps.

17. The apparatus of claim 15, wherein the receiver is further configured to:
receive a configuration indicating that the one or more first puncturing locations are reserved for the DMRS;
based on the one or more first puncturing locations, demodulate the charging signal using the DMRS, wherein removing the one or more signal components includes removing the demodulated charging signal from the data signal to generate a representation of the data signal; and
demodulate the representation of the data signal.

18. The apparatus of claim 15, wherein the receiver is further configured to receive a configuration message configuring the apparatus with one or more of:
a first set of ports for receiving the DMRS to enable energy harvesting based on the charging signal; or
a second set of ports for receiving the DMRS to enable cancelation of the charging signal from the data signal.

19. The apparatus of claim 15, wherein the data signal is punctured at one or more second puncturing locations to enable transmission of at least a second portion of the DMRS.

20. A method of wireless communication performed by a first device, the method comprising:
transmitting a data signal to a second device;
transmitting a charging signal that is based on one or more time domain taps; and
receiving, from a third device based on the charging signal, a feedback signal associated with the charging signal, wherein the feedback signal indicates at least one parameter that is detected by the third device and that is associated with the one or more time domain taps.

21. The method of claim 20, wherein the at least one parameter includes one or more of a statistical mean associated with the one or more time domain taps, a variance associated with the one or more time domain taps, or cross-tap correlation data associated with the one or more time domain taps, and wherein the cross-tap correlation data includes one or more of a mean vector or a covariance matrix.

22. The method of claim 20, wherein the charging signal is based on one or more of a number of the one or more time domain taps, a location of at least one of the one or more time domain taps, a transmit power of at least one of the one or more time domain taps, or a distribution associated with the one or more time domain taps.

23. The method of claim 20, further comprising transmitting an indication modifying a number of the one or more time domain taps to change an energy level associated with the charging signal.

24. The method of claim 20, wherein the charging signal is deterministically generated by the first device based on a set of parameters that are common to a plurality of user equipment (UE) devices including the second device, that are specified by a wireless communication protocol, or both.

25. The method of claim 24, further comprising transmitting a control message indicating the set of parameters, wherein the control message includes a configuration message, a medium access control (MAC) control element (MAC-CE) message, downlink control information, or a sidelink resource pool configuration message.

26. The method of claim 20, wherein the charging signal is randomly or pseudo-randomly generated by the first device.

27. The method of claim 20, wherein the charging signal is punctured at one or more first puncturing locations to enable transmission of at least a first portion of a demodulation reference signal (DMRS) to enable estimation of the charging signal.

28. The method of claim 27, wherein a first number of the one or more first puncturing locations is based on a second number of the one or more time domain taps.

29. The method of claim 27, further comprising transmitting a configuration message indicating one or more of:
a first set of ports for receiving the DMRS to enable energy harvesting based on the charging signal; or
a second set of ports for receiving the DMRS to enable cancelation of the charging signal from the data signal.

30. The method of claim 27, wherein the data signal is punctured at one or more second puncturing locations to enable transmission of at least a second portion of the DMRS.
